(19) United States
(12) Patent Application Publication
(10) Pub. No.: US 2015/0371333 A1
(43) Pub. Date: Dec. 24, 2015

(54) METHOD FOR EXCHANGING AN ASSET FOR SHARES OF AN INVESTMENT FUND IN AN INVESTMENT FUND CORPORATION

(71) Applicant: Purpose Investments Inc., Toronto (CA)

(72) Inventors: Som Seif, Toronto (CA); Vladimir Tasevski, Toronto (CA)

(73) Assignee: Purpose Investments Inc., Toronto (CA)

(21) Appl. No.: 14/610,914

(22) Filed: Jan. 30, 2015

Related U.S. Application Data
(60) Provisional application No. 62/015,038, filed on Jun. 20, 2014.

(51) Int. Cl. G06Q 40/06

(52) U.S. Cl. CPC G06Q 40/06

(57) ABSTRACT

Described is a method for exchanging a subscription asset for shares of an investment fund in an investment fund corporation, the method comprising: considering a subscription asset offered by a client; considering an equivalent value asset offered by an institutional investor in exchange for shares of an in-kind fund in the investment fund corporation; receiving the subscription asset from the client in exchange for subscription shares of the in-kind fund; receiving the equivalent value asset from the institutional investor in exchange for shares of the in-kind fund; holding the subscription asset in the in-kind fund; and converting the subscription shares of the in-kind fund into shares of an investment fund in the investment fund corporation.

### CROSS-REFERENCE TO RELATED APPLICATIONS

This application claims benefit of U.S. Provisional Application No. 62/015,038 filed on Jun. 20, 2014, entitled “METHOD FOR EXCHANGING AN ASSET FOR SHARES OF AN INVESTMENT FUND IN AN INVESTMENT FUND CORPORATION.” The disclosure of this U.S. Provisional Application is incorporated herein by reference in its entirety.

### FIELD OF THE INVENTION

The present invention pertains to a method for exchanging an asset for shares of an investment fund in an investment fund corporation.

### BACKGROUND

An investment fund is a pool of funds collected from many investors who have a similar investment objective. A professional investment manager invests this money on behalf of the group of investors who have invested in the investment fund. Investors share an investment fund's income, expenses, gains and losses in proportion to their interest in the investment fund. Investment funds can give individuals the advantages of a more professional, more accessible, more diversified, and less time-consuming way of investing in a portfolio of securities.

Investment funds invest in and own different types of investments, depending on their investment objectives. These investments may include equities like shares, fixed-income securities like bonds and cash or cash equivalents like treasury bills, or units of other investment funds. The value of these investments will change from day to day, reflecting changes in interest rates, economic conditions, financial markets and company specific news and developments. As a result, the value of an investment fund's units or shares fluctuates on a daily basis.

An investment fund can be organized as an investment trust, an investment fund corporation, or a partnership. An investment trust is a standalone entity that can issue units, as well as multiple series of units to its investors. An investment fund corporation can have one or more classes of shares whereby each class represents a separate investment fund whose performance is independent of the performance of the other investment funds (share classes) offered by that corporation. Each share class can have multiple series of shares for different types of investors. Each series has its own fees and expenses which are tracked separately. Those fees and expenses are deducted when calculating the net asset value for that series thereby reducing the net asset value by that amount. An investor's interest in an investment fund is represented by the number of units or shares of that investment fund that the investor owns.

Some classes of shares are offered in more than one series. A multi-series structure recognizes that different investors may seek the same investment objective, yet require different level of investment advice and/or service. Each series represents an investment in the same investment portfolio of the investment fund. However, each series may charge a different management fee and incur its own specific fees and expenses. As a result, a separate net asset value (NAV) per share is calculated for each series, usually on a daily basis. In addition, series of shares of an investment fund can also be differentiated in two types according to the way they can be purchased. The first type is most commonly known as mutual fund shares (MF shares) and can be purchased by investors only once a day at that day's NAV. Another type of series is called exchange-traded shares (ETF shares) and can be purchased by investors at their current market price over a stock exchange in Canada, the United States, and other countries during regular market trading hours. ETF and MF shares and units can be used in both trusts and fund corporations. The price of the ETF shares during market hours varies with the value of the underlying portfolio securities that the investment fund is invested in.

The trading of ETF shares is facilitated by registered investment dealers or market makers who have a contract with the investment fund manager to continuously provide market making services for the ETF shares by purchasing an unlimited number of ETF shares at a certain price level (Bid Price) and are willing to sell unlimited number of ETF shares at higher price level (Ask Price). This market making service is made possible by the fact that the market makers can purchase or redeem an unlimited number of ETF shares directly from or to the investment fund on a daily basis at a price equal to that day's NAV of the ETF shares in the investment fund. When purchasing ETF shares, the market maker can pay for that purchase either with cash or by delivering a basket of the securities and cash with total value equal to the dollar amount of the purchase order (“In-Kind Purchase”). Similarly, when market makers redeem their ETF shares, the proceeds for that redemption can be paid either in cash or by the investment fund delivering a basket of securities and cash to the market maker with a value equal to the value of the redemption order (“In-Kind Redemption”). An investor can also purchase or redeem mutual fund shares for cash or by an In-Kind Purchase or an In-Kind Redemption.

Within an investment fund corporation an investor can buy a series of shares of an investment fund and can transfer or convert from one series of shares of an investment fund to another share series of the same or other investment fund. The investor can also convert ETF shares of one fund to ETF shares of another fund. Converting shares of funds, which involves moving money from one investment fund to another, is also known as switching. An investor can also redeem their investment by selling part or all of their fund shares to the investment fund. In Canada, a switch transaction from one investment fund to another investment fund when both funds are within the same investment fund corporation is generally a non-taxable event, and allows investors to change their investment exposure on a tax-deferred basis until the investor decides to redeem the shares for cash.

There remains a need for enabling an investor to exchange an asset for shares of an investment fund in an investment fund corporation.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method for exchanging an asset for shares of an investment fund in an investment fund corporation.

In accordance with an aspect, there is provided a method for exchanging a subscription asset for shares of an investment fund in an investment fund corporation, the method comprising: considering a subscription asset offered by a client; considering an equivalent value asset offered by an institutional investor in exchange for shares of an in-kind fund in the investment fund corporation; receiving the subscription asset from the client in exchange for subscription shares of the in-kind fund; receiving the equivalent value asset from the institutional investor in exchange for shares of the in-kind fund; holding the subscription asset in the in-kind fund; and converting the subscription shares of the in-kind fund into shares of an investment fund in the investment fund corporation.

In accordance with another aspect there is provided a method for exchanging a subscription asset for shares of an investment fund in an investment fund corporation on a tax-deferred basis, the method comprising: considering a subscription asset offered by a client; considering an equivalent value asset offered by an institutional investor in exchange for shares of an in-kind fund in the investment fund corporation; receiving the subscription asset from the client in exchange for subscription shares of the in-kind fund; receiving the equivalent value asset from the institutional investor in exchange for shares of the in-kind fund; holding the subscription asset in the in-kind fund; and converting the subscription shares of the in-kind fund into shares of an investment fund in the investment fund corporation.

In accordance with another aspect there is provided a computer-implemented method for exchanging a subscription asset for shares of an investment fund in an investment fund corporation, the method comprising: considering a subscription asset offered by a client; considering an equivalent value asset offered by an institutional investor in exchange for shares of an in-kind fund in the investment fund corporation; receiving, by a computer programmed to perform such receiving, the subscription asset from the client in exchange for subscription shares of the in-kind fund; receiving, by a computer programmed to perform such receiving, the equivalent value asset from the institutional investor in exchange for shares of the in-kind fund; holding the subscription asset in the in-kind fund of the investment fund corporation; and converting, by a computer programmed to perform such converting, the subscription shares of the in-kind fund into shares of an investment fund in the investment fund corporation; and tracking, by a computer programmed to perform such tracking, the subscription asset and history of transactions thereof while the asset is held by the investment fund corporation.

In accordance with one embodiment, the method further comprises converting the shares of the investment fund into redemption shares of the in-kind fund and redeeming the redemption shares for cash.

In accordance with another embodiment, the method further comprises calculating the amount of capital gains to be distributed to the client and the institutional investor.

In accordance with another embodiment, the amount of capital gains realized upon redemption is shared between the client and the institutional investor.

In accordance with another embodiment, the investment fund further comprises at least one series of shares for investors purchasing shares of the investment fund with cash.

In accordance with another embodiment, the institutional investor is a financial institution, bank, holding company, insurance company, pension fund, individual investor or other institution.

In accordance with another embodiment, the subscription asset is a stock, security, equity, shares of a company, partnership interest, capital property, resource property, real property, or combination thereof.

In accordance with another embodiment, the subscription asset is an equity of one or more publicly traded companies or a capital stock of a private corporation.

In accordance with another embodiment, the method further comprises considering and/or receiving more than one subscription asset offered by the client.

In accordance with another embodiment, the method is done on a tax-deferred basis to the client.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is a flowchart depicting one exemplary subscription process into the Investment Fund Corporation via an in-kind transfer;

FIG. 2 is a flowchart depicting the steady state of the Investment Fund and the In-Kind Fund in the Investment Fund Corporation subsequent to subscription of the Client and Institutional Investor; and

FIG. 3 is a flowchart depicting one exemplary redemption process.

### DETAILED DESCRIPTION OF THE INVENTION

### Definitions

Unless defined otherwise, all technical and scientific terms used herein have the same meaning as commonly understood by one of ordinary skill in the art to which this invention belongs.

As used in the specification and claims, the singular forms “a”, and “the” include plural references unless the context clearly dictates otherwise.

The term “comprising” as used herein will be understood to mean that the list following is non-exhaustive and may or may not include any other additional suitable items, for example one or more further feature(s), component(s) and/or elements(s) as appropriate.

As used herein, the terms “Investment Fund Corporation” and “Fund Corporation” refer to a corporation that owns a pool of investment assets. The investment fund corporation offers one or multiple share classes and the value of each share classes is based on a portion of the portfolio of assets of the corporation. The Investment Fund Corporation invests the capital of Client Investors in securities and/or financial instruments.

As used herein, the term “Investment Fund” refers to an investment vehicle which invests monies it receives from investors in an investment portfolio or pool of various securities. Each Investment Fund has a different investment objective and, as a result, invests in and holds different securities in its investment portfolio. For example, the investment portfolio of a Canadian balanced fund will typically contain Canadian equity and fixed income securities, while a foreign equity fund will contain primarily foreign equity securities. An investor's interest in the investment fund is expressed in “units” if the investment fund purchased is an investment trust, or “shares” if the investment fund purchased is an investment fund corporation. The number of units or shares an investor owns in comparison to the total number issued by the investment fund determines his or her ownership interest in the fund. Some non-limiting examples of investment funds are equity funds, dividend funds, bond funds and money market funds. The singular term “Investment Fund” is understood to encompass one or more of Investment Funds within the same Investment Fund Corporation (i.e. Investment Fund A, Investment Fund B, Investment Fund C, etc. . . . ), as Investment Fund Corporations are likely to offer more than one Investment Fund.

As used herein, the terms “Client” and “Client Investor” refer to an individual, entity, organization or group of individuals holding one or more stock(s) and/or security(ies), in the form of a subscription asset, who desires to exchange the stock or security for an equivalent value of shares of an investment fund.

As used herein, the term “Institutional Investor” refers to an individual, entity, organization or group of individuals who desire to purchase shares of an investment fund that will hold stocks or securities exchanged by the Client. In some non-limiting examples, the Institutional Investor can be a financial institution, bank, holding company, insurance company, pension fund, individual investor or other institution.

As used herein, the term “subscription asset” refers to a property which is owned by the Client and can be offered to the Investment Fund Corporation in exchange for shares in the investment fund corporation. Non-limiting examples of a subscription asset include stock, security, equity, shares of a company, partnership interest, capital property, resource property, real property or combination thereof. The subscription asset can be listed and trading on a public stock exchange and/or be an equity of one or more publicly traded companies or capital stock of a private corporation. The subscription asset can also be more than one subscription asset, or a basket of subscription assets.

As used herein, the term “equivalent value asset” refers to a property which is delivered by the Institutional Investor, which matches the value of the subscription asset offered by the Client. The equivalent value asset can comprise cash, a security, a basket of securities, or a combination thereof.

As used herein, the term “Exchange-Traded Fund (ETF)” is a type of shares of an investment fund that trades like a stock on an exchange. An ETF provides the diversity of an investment fund as well as the ability to buy or sell its shares on a stock exchange at any time during regular market hours at its current market price.

As used herein, the term “Net Asset Value (NAV)” as it refers to a share, refers to the value of a fund price per share or exchange-traded fund (ETF) per share value, calculated by dividing the total value of all the securities in its portfolio, less any liabilities, by the total number of fund shares outstanding.

As used herein, the term “Capital Gains” refers to the profits that an investor realizes when he or she sells a capital asset for a price that is higher than the average purchase price paid by the individual for the capital asset. An investor can own shares that appreciate every year, but the investor does not incur a realized capital gain on the shares until they are sold.

Herein is provided a method for exchanging an asset for shares of an investment fund in an investment fund corporation.

The present method enables a Client to purchase shares of an Investment Fund by paying for them by delivering a stock/security and/or cash (subscription asset) of the equivalent value of the Investment Fund shares purchased. The Client can also use more than one stock or security or a basket of stocks and/or securities to purchase shares of the Investment Fund. This in-kind exchange offers a Client Investor the ability to diversify their existing concentrated investments through the exchange of one or more securities in the form of a subscription asset for shares of one or more Investment Funds of the Fund Corporation, preferably on a tax-deferred basis.

The Fund Corporation comprises an In-Kind Exchange Fund (“In-Kind Fund”) comprising multiple series, and at least one Investment Fund comprising multiple series. Client Investors are provided with the opportunity to acquire shares of the In-Kind Fund by exchanging one or more eligible subscription assets. In practice, the Client exchanges the subscription asset for subscription shares (“Series S shares”) of the In-Kind Fund at the discretion of the investment manager on a tax deferred basis. The In-Kind Fund is an investment fund or share class of the investment fund corporation and can hold the in-kind securities exchanged by the Client until the Client redeems the shares it received in exchange for the subscription asset. Clients who purchase Series S shares of the In-Kind Fund will agree to convert their Series S shares to shares of an Investment Fund (“Series X shares”) within the Fund Corporation. The Investment Fund can comprise multiple Series X shares. As a result, a Client Investor may diversify a single stock holding into one or more Investment Funds on a tax deferred basis. The Fund Corporation can also allow Client Investors to switch between series or funds without triggering a taxable disposition.

Shares of the Investment Fund may be purchased by either: (i) an exchange of Subscription shares of the In-Kind Fund, (ii) cash payment, or (iii) an exchange of an equivalent value asset, or combination thereof. Series X shares of the Investment Fund can also be offered on a continuous basis. In one preferable embodiment, Series X shares are only available to Client Investors who hold Series S shares and can acquire Series X shares by converting their Series S shares into Series X shares. In one embodiment, the net asset value (“NAV”) per Series S share is fixed. In another preferable embodiment, the NAV per Series S share is fixed at $1.00 per share.

In a preferable embodiment of the present method, the conversion can occur without triggering a taxable disposition to the Client if the Client elects to do so when exchanging their subscription asset for shares of the Investment Fund Corporation.

The In-Kind Fund also offers Redemption shares (“Series R shares”). In one preferable embodiment, holders of Series X shares who wish to redeem their shares convert their Series X shares of the Investment Fund for Series R shares of the In-Kind Fund and then redeem such shares for cash. In one embodiment, the net asset value (“NAV”) per Series R share is fixed. In another preferable embodiment, the NAV per Series R share is fixed at $1.00 dollar per share.

Investors holding Series X shares may also be required to pay an additional fee on the NAV of the In-Kind Fund, and at the Investment Fund manager's option, also an amount in respect of hedging costs incurred in connection with the holdings of the In-Kind Fund, on a pro-rata basis.

In Canada, in conjunction with in-kind purchase of shares by the Investment Fund, the Client can file a Section 85(1) election under the Income Tax Act (Canada) that provides for the in-kind purchase to be a non-taxable transaction at the time of the purchase. This in-kind exchange allows the Client to exchange and thus diversify their investment exposure from the in-kind security(s) or subscription asset to any of the Investment Funds offered by the investment fund corporation on a tax-deferred basis. This type of exchange benefits the Client by deferring the payment of capital gains tax. A Canadian Client will be required to complete a joint Canadian income tax election made under subsection 85(1) of the Income Tax Act (Canada) (the “Tax Act”) with the corporation. This will permit the Client to defer paying tax on all or a portion of any accrued capital gain on the subscription asset(s).

Subscription

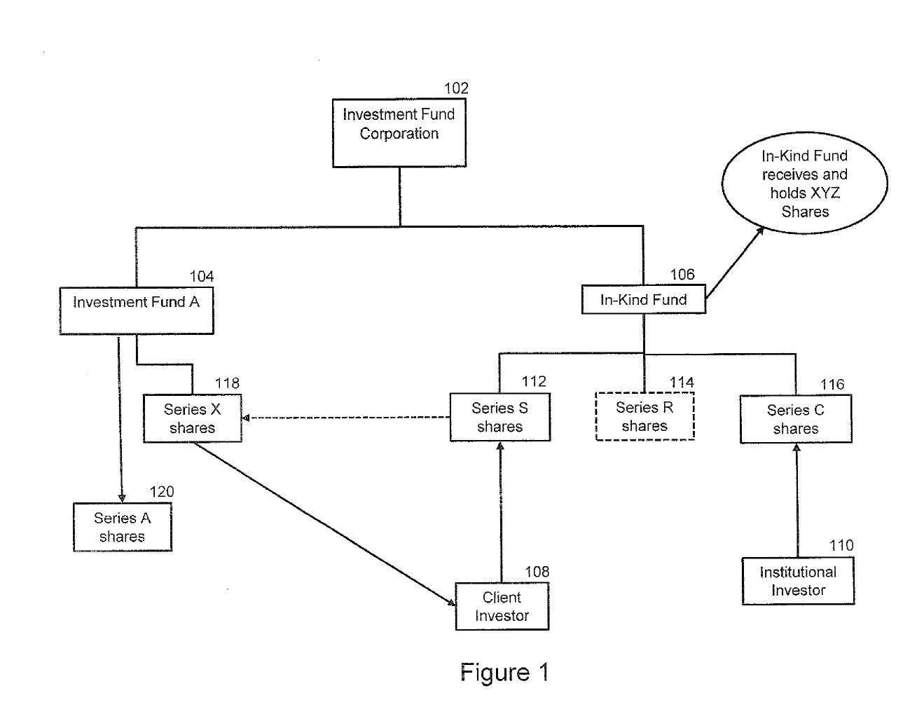

A flowchart depicting one exemplary subscription is shown in FIG. 1. Within the Fund Corporation (102), an Investment Fund (104) is enabled to accept subscription by a Client (108) who has transferred a security to the In-Kind Fund (106) in the form of a subscription asset. The “In-Kind Exchange Fund” or “In-Kind Fund” (106) within the Fund Corporation (102) is set up to hold all of the in-kind securities transferred by Clients. In one preferable embodiment, a separate series of shares is created of publicly offered funds of the corporation that would be used only by the investors using in-kind subscriptions. For the purpose of clarity, shares of the Investment Fund purchased for cash are herein referred to as “Series A shares” (120), and shares of the Investment Fund obtained by way of an in-kind transfer are herein referred to as “Series X shares” (118).

In one exemplary structure, the In-Kind Fund (106) can offer three different series of shares:
1. Series S shares—available to Clients who subscribe by delivering a subscription asset. Series S shares can have a fixed value per share. In one preferable embodiment, the fixed value of the Series S shares is $1 NAV per share.
2. Series R shares—used for redemption of Series S shares of investment funds which were purchased by clients in exchange for a transfer of a security, i.e. a Client who initially subscribed for the In-Kind Fund by transferring a security. Series R shares preferably have fixed $1 NAV per share. Separate Series R shares are available for each Client Investor who redeems on any given day, i.e. R1, R2, R3 . . . .
3. Series C shares—available for purchase by an Institutional Investor. The NAV of Series C shares is variable and will depend on the performance of the in-kind subscription asset delivered in the form of a subscription asset by clients who subscribed for Series S shares. Each Institutional Investor has separate Series C shares, i.e. C1, C2, C3 . . . .

A Client subscribes for shares of the Fund Corporation (102) by transferring an amount of an agreed-upon stock(s) or security(s) in the form of a subscription asset in exchange for Series S shares (112) of the In-Kind Fund (106). A purchase order can be placed for a series of shares to the fund manager. The manager of the Fund Corporation notifies the Client of the value (price) of the in-kind subscription asset which the Client (108) agrees to exchange for an agreed upon number of Series S shares (112) based on the value of the subscription asset. To complete the subscription order, the Client then pays for the Series S shares (112) of the In-Kind Fund (106) by delivering the agreed-upon subscription asset, and in return the Client receives Series S shares of the In-Kind Fund. If the transfer is occurring in Canada, the Client would also submit the aforementioned 85(1) tax election form in order for the Client's subscription to the In-Kind Fund to be processed as a non-taxable event.

The present technology enables the Fund Corporation to: 1) record and track the Client's adjusted cost base of the subscription asset and 2) record, track and add the in-kind subscription shares to the portfolio of the corporation at the adjusted cost base provided by the Client. The adjusted cost base (ACB) of a Client can be tracked during all the time the Client is invested in the Investment Fund Corporation. Tax accounting for the Fund Corporation can be accomplished by recording and tracking the subscription asset at its ACB which is provided by the Client. Accounting for valuation purposes can be accomplished by adding the subscription asset at market value at the time of subscription. Thus the subscription asset transferred in-kind by the Client, both at the Client level and at the Investment Fund Corporation level, can be effectively tracked.

The Fund Corporation (102) tracks and records the ACB for each Client of the corporation on a daily basis as follows: for an initial delivery of a security or subscription asset, the Fund Corporation (102) records both the ACB provided by the Client Investor (108) and the market value of the subscription asset. In the case where the Client (108) transfers the same subscription asset in more than one packet and at different times, for every additional delivery of the same security, the ACB for that security for that Client (108) is recalculated by averaging the ACB of the total number of shares of the security delivered by the Client. Similarly the market value is adjusted to account for the market values of all shares delivered of such security.

The Institutional Investor (110) subscribes for Series C shares of the In-Kind Fund (106) with an equivalent value asset having an equivalent value to the subscription asset received from the Client.

In one exemplary embodiment, the Fund Corporation receives a subscription order for the In-Kind Fund from a Client. Upon an agreement between the Fund Corporation and the Client, the Fund Corporation exchanges the subscription asset with the Client for Series S shares and the Institutional Investor buys Series C shares of the In-Kind Fund in exchange for an equivalent value asset.

Conversion

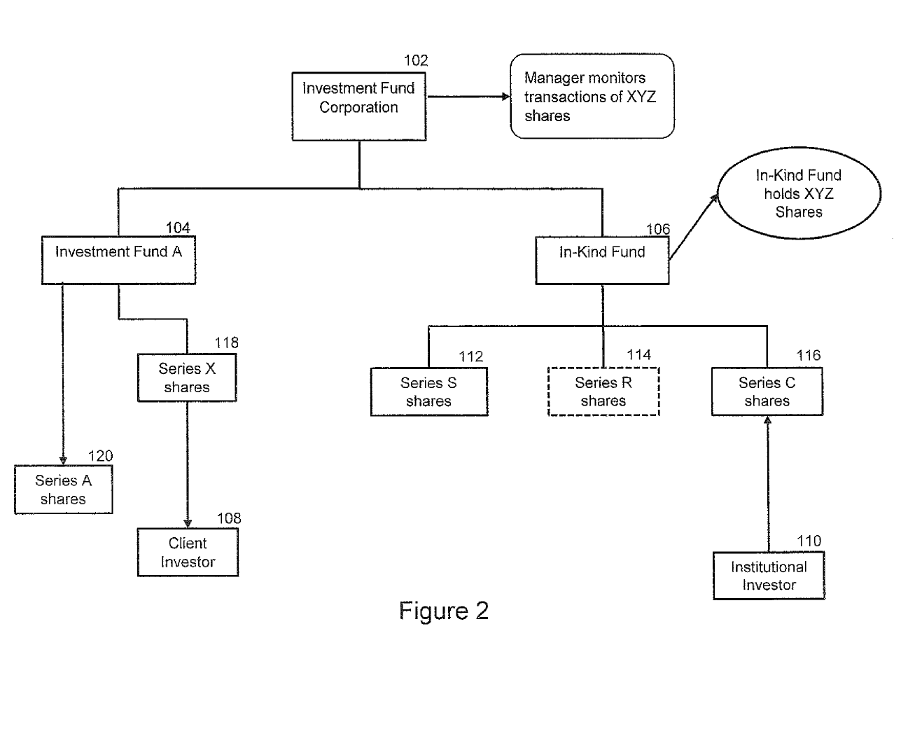

As shown in FIG. 2, a Client holding Series S shares (112) of the In-Kind Fund (106) can convert the Series S shares (112) into Series X shares (118) of one or more Investment Fund(s) (104) of the Investment Fund Corporation (102). Although FIGS. 1-3 show a single Investment Fund A (104), it is understood that the Investment Fund Corporation (102) can comprise multiple investment funds. Once a Client receives Series X shares (118) of the Investment Fund (104), the Client (108) can then switch between investment funds offered by the Fund Corporation (102) as they desire on a tax deferred basis. In this way the Fund Corporation (102) enables the Client (108) to manage their portfolio by switching between different investment funds within the Fund Corporation (102) without triggering a taxable disposition.

When a Client converts Series S shares (112) to Series X shares (118), an amount of cash or asset(s) equal to the value of the Series S shares (112) is required in order for the manager to be able to invest the proceeds from the conversion into the portfolio of the fund issuing the Series X shares (118). In a typical conversion transaction, portfolio assets of the fund are sold to raise cash to deliver to the Investment Fund on a conversion of shares from the In-Kind Fund. However, in the case where the Client (108) subscribes with an in-kind subscription asset, and to maintain the non-taxable status of such subscription, the in-kind subscription asset must not be sold, otherwise the Client (108) would have to pay capital gains tax on the sale of the subscription asset. Instead, the Fund Corporation (102) raises the equivalent value asset by offering Series C shares (116) of the In-Kind Fund (106) to the Institutional Investor (110) for the equivalent value of Series S shares (112) of the In-Kind Fund (106). The Institutional Investor (110) subscribes to the In-Kind Fund (106) for a dollar amount equivalent to the value of the subscription asset.

The Client's subscription to the In-Kind Fund settles when the Client transfers the in-kind subscription asset to the In-Kind Fund and in return receives Series S shares of the In-Kind Fund. The conversion is initiated to convert Series S shares of the In-Kind Fund into Series X shares of the Investment Fund. An equivalent value asset needs to be raised or sourced as required to fund the conversion of the Client's subscription amount into the Series X shares (118) of the one or more Investment Funds (104) offered by the Fund Corporation (102). The subscription of the Institutional Investor (110) settles when the equivalent value asset is delivered to the In-Kind Fund in exchange for Series C shares.

In one exemplary conversion process the Client receives Series S shares. At a later time, the conversion occurs from Series S shares of the In-Kind Fund to Series X shares of the Investment Fund. The Investment Fund also receives the equivalent value asset for the purchase or exchange of the Series X shares from the In-Kind Fund, and the Client receives the Series X shares.

As a result of the transfer, the In-Kind Fund receives the subscription asset in the form of an in-kind security(s) from the Client Investor, and the equivalent value asset from the Institutional Investor. The In-Kind Fund then has the equivalent value asset required to settle the conversion of Series S shares. The equivalent value asset can then be invested or incorporated into the portfolio of the Investment Fund into which the Client converts his Series S shares at the discretion of the Fund manager. Other share series of the Investment Fund can be made available to other investors seeking to invest in the Investment Fund with cash. This enables the corporation to keep track of the transaction history and ACB for the Client.

The Institutional Investor holds Series C shares of the In-Kind Fund, and the Client Investor holds Series X shares of the Investment Fund. The Client Investor can also convert to any other Investment Fund in the Fund Corporation on a tax-deferred basis.

The Client will thus be able to enter into an agreement to mitigate undesirable single stock exposure and the Institutional Investor will be able to enter into an agreement with the comfort of not taking on undesirable market exposure risk. The present method also enables an economically viable way for a Client to exchange an asset for shares of an investment fund while mitigating a concentration risk of holding a single security or asset. Accuracy in the tracking of the asset and history of transactions thereof also reduces or eliminates the risk of improper reporting. Thus the liability to the Investment Fund Corporation, the Investment Fund Manager, Client Investor and the Institutional Investor is reduced and an accurate tax report for the Fund Corporation, the Institutional Investor and the Client can be prepared with confidence.

The fund structure can also comprise using classes of shares as separate investment funds within the same corporation and dividing each class of shares into several series of shares including non listed mutual fund shares (in one or more series) and listed exchanged traded series of shares (ETF shares). This structure allows holders of ETF shares of a fund to switch their ETF shares of a fund into ETF shares of another fund (in addition to and in the same way that the holders of mutual fund shares of a fund may switch their shares into mutual fund shares of another fund in the structure). In this way a suite of mutual fund shares and a suite of ETF shares can been combined into a single investment fund platform with switching capability whereas before mutual fund shares and ETF shares were available only in separate funds.

Computer hardware and software may be used to create and access accounts for tracking the activities and transactions of the Client and Institutional Investor within the Fund Corporation. The tracked transactions include the initial transfer of the subscription asset, subscription to the In-Kind Fund, conversion to the Investment Fund, tracking of the ACB of the client, and redemption from the Investment Fund. Daily tracking of any purchases and sales of subscription assets can be done by the Fund Corporation. Whenever there is a purchase or sale transaction which includes a security held by both the In-Kind Fund and any one of the other Investment Funds of the Fund Corporation, an adjustment and recalculation will be to be made for accounting purposes for both the Client and the Fund Corporation. This facilitates the calculation of the amount of capital gains to be distributed should there be a redemption involving the same subscription asset.

The steps of subscription, conversion and redemption may comprise the computer updating a computer database to debit and credit accounts to reflect ownership, history and value of the shares through time, and capital gains calculations. Similarly, in embodiments comprising different share classes, computers may be programmed to track the subscription, conversion and redemption of one type of share to another. Computers may also be used to create, buy, and sell different assets or funds to be added to or subtracted from the Client's or Institutional Investor's portfolios, as needed, or for otherwise maintaining the record of financial assets held by the Investment Fund, the Client and the Institutional Investor.

Instructions relating to specific actions to be taken by the computer programs in administering the Investment Fund and maintaining records of the Investment Fund, the Client and the Institutional Investor may be entered by any means, including entry directly using telephone or computer access over the Internet, or entry by a representative of the Fund Manager pursuant to instructions received from an Investor via mail, via telephone, in person, or in an automated process. Computers are also typically used to calculate the NAV of a share in the Investment Fund.

Embodiments of the present invention include a computer program code-based product, which includes a non-transitory computer readable storage medium having program code stored therein which can be used to instruct a computer to perform any of the functions, methods and/or transactions associated with the present invention. The computer storage medium includes any of, but not limited to, the following: cloud storage, CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

Various transactions and other components of the embodiments discussed hereinabove may be configured as hardware, as computer readable code stored in any suitable non-transitory computer usable medium, such as ROM, RAM, flash memory, phase-change memory, magnetic disks, cloud storage, etc., and/or as combinations thereof, without departing from the scope of the present invention. Actions and transactions shown and described herein, including the various transfers, conversions, redemptions and exchanges of securities, assets and/or cash described hereinabove, may be effected electronically, with or without a corresponding exchange of physical assets. Moreover, any of the features described with respect to any of the embodiments described herein may be similarly applied to any of the other embodiments described herein without departing from the scope of the present invention.

The present method can be implemented in various computing environments, for example, on a conventional personal computing system or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of the present invention may be implemented by one skilled in the art of computer systems and/or software design.

Redemption

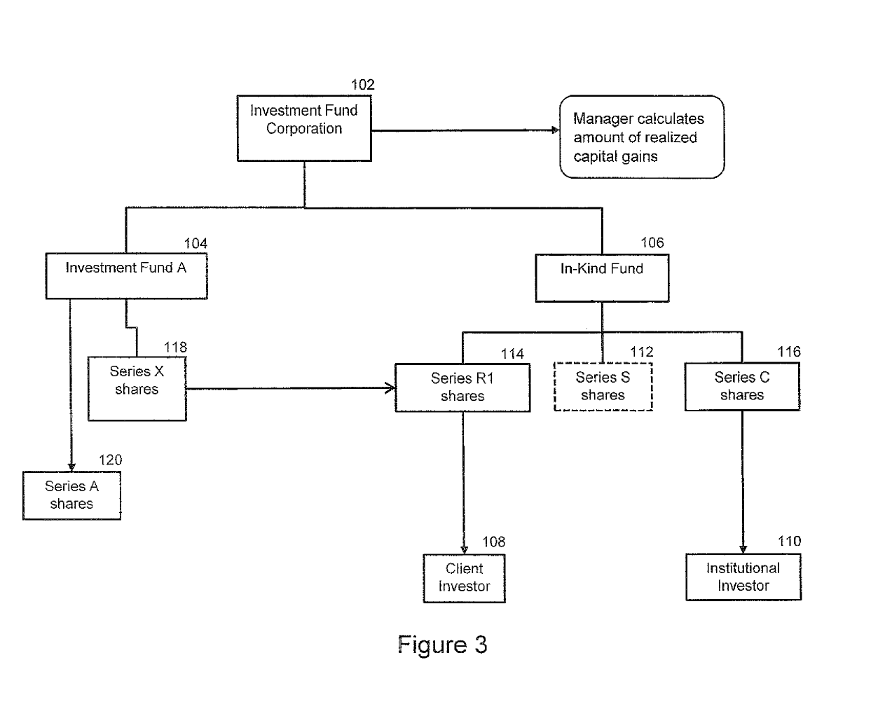

An exemplary flowchart depicting the redemption process is shown in FIG. 3. As shown, Series X shares of the Investment Fund can be redeemed by the Client by initially converting them into Series R shares of the In-Kind Fund. Redemption of the Client's investment from Series X shares is a multi-step process. First, Series X shares of the Investment Fund are converted into Series R shares of the In-Kind Fund. To process the conversion, the Fund manager needs to sell a portion of the portfolio of the Investment Fund.

Concurrently, the Institutional Investor redeems Series C shares equal to the current market value of the in-kind security(s) or subscription asset which the Client delivered upon subscription. With the redemption of the subscription asset and the sale of the portion of the Investment Fund, the Investment Fund Corporation realizes capital gains equal to the difference between the market value of the security(s) on the redemption date and the ACB. The adjusted cost base (ACB) is calculated to determine the cost of the investment for tax purposes for the Fund Corporation. The ACB calculation is used to determine capital gains or losses for income tax purposes, and applies when the Client seeks to redeem their investment for cash.

The In-Kind Fund then pays a capital gains dividend on Series R shares. The capital gains is calculated as the difference between the current value of the Series X shares and the ACB of the in-kind security(s) the Client used to pay for the subscription (subscription asset). This capital gains dividend is calculated separately for each client. After the capital gains dividend is recorded, the Client's ACB is adjusted upwards by such amount and the Series R shares (114) can be redeemed for cash.

A single redemption Series R share can be used for only one investor on any given day. In one embodiment of the invention, in order to be able to redeem multiple clients on the same day, the In-Kind Fund offers multiple series of Series R shares. For a day on which there will be multiple redemptions of Series R shares of the In-Kind Fund, a separate Series R share is used for each investor redeeming on any given day. Multiple Series R shares (114) (e.g. R1, R2, R3, R4 . . . ) of the In-Kind Fund can be offered to allow for multiple redemptions on any day such that only one Client Investor is in any Series R share at a given time. The Institutional Investor may choose to redeem Series C shares of the In-Kind Fund in exchange for the net asset value of such shares, which may be satisfied by delivering the subscription shares originally transferred by the Client at subscription, or an equivalent value of in-kind securities and/or cash.

### Example

To gain a better understanding of the invention described herein, the following example is set forth. It should be understood that this example is for illustrative purposes only. Therefore, it should not limit the scope of this invention in any way.

Reference is made to FIGS. 1-3 which sets out exemplary embodiments of the present method.

A Client offers up a subscription asset in the form of 100,000 shares of XYZ Corp. (XYZ) stock to the Fund Corporation. The Fund manager considers whether the subscription asset offered up by the Client would be acceptable for exchange. If the Fund manager decides that the asset offered by the Client is acceptable, the Fund Corporation seeks out an Institutional Investor interested in subscribing for Series C shares of the In-Kind Fund by way of an exchange for cash or an equivalent value asset. Once the subscription asset offered by the Client has been matched with an Institutional Investor willing to purchase an equivalent value of Series C shares, the subscription process can begin.

At the subscription date the Client Investor has the 100,000 shares of XYZ stock with a market value of $50/share or a total value of $5,000,000 or $5.0 m. The Client's ACB for the XYZ shares is $0. The Client subscribes for 5,000,000 Series S shares of the In-Kind Fund worth $5,000,000, at a NAV of $1 per share. The Client also optionally completes and files a tax election form that enables the in-kind purchase of Series S shares to be a non-taxable transaction at the time of the purchase.

The Institutional Investor subscribes with cash for Series C shares for aggregate amount of $5,000,000. The Institutional Investor then receives and holds Series C shares. At the same time, the Fund manager records the in-kind subscription of XYZ shares with a market value of $5.0 m and an ACB of $0. Now the Fund Corporation has $5.0 m of unrealized capital gains.

Following the trade date, the Client converts the Series S shares of the In-Kind Fund to Series X shares of Investment Fund A. The cash held by the In-Kind Fund from the Series C subscription provided by the Institutional Investor is used to fund the conversion and investment of $5.0 m into the portfolio of securities of Investment Fund A.

When the Client wants to redeem its investment for cash, the Series X shares of the Investment Fund may be converted into Series R shares of the In-Kind Fund. For the purpose of this example, the value of Series X shares increased from $5.0 m to $6.0 m (a gain of $1.0 m) and the value of XYZ Shares increased from $5.0 m to $5.5 m, for a total gain of $5.5 m since the ACB is $0. The total capital gains amount for the Fund Corporation is then calculated as $6.5 m ($1.0 m+$5.5 m), which must be distributed to the redeeming shareholders, i.e. both the Client and the Institutional Investor, if the Institutional Investor decides to redeem the Series C shares.

At the time of the redemption, the In-Kind Fund declares a capital gains dividend of $6.0 m to the Client. This consists of $5.0 m or the difference between ACB of $0 and market value of XYZ shares on the subscription date. In addition, the Client also receives an additional capital gain of $1.0 m for the appreciation of Investment Fund A from $5.0 m to $6.0 m. If the Institutional Investor redeems, it will have a capital gain equal to the balance of $0.5 m, which is the appreciation of XYZ stock from $5.0 m to $5.5 m between the time of subscription and the time of the redemption. In this transaction, the total capital gains dividend to be distributed by the Investment Fund Corporation is $6.5 m.

All publications, patents and patent applications mentioned in this Specification are indicative of the level of skill of those skilled in the art to which this invention pertains and are herein incorporated by reference to the same extent as if each individual publication, patent, or patent application was specifically and individually indicated to be incorporated by reference.

Although the present invention has been described with reference to the preferred embodiments, it is to be understood that modifications and variations may be resorted to without departing from the scope of the invention, as those skilled in the art readily understand. Such modifications and variations are considered to be within the purview and scope of the invention and the appended claims.

1. A method for exchanging a subscription asset for shares of an investment fund in an investment fund corporation, the method comprising:
considering a subscription asset offered by a client;
considering an equivalent value asset offered by an institutional investor in exchange for shares of an in-kind fund in the investment fund corporation;
receiving the subscription asset from the client in exchange for subscription shares of the in-kind fund;
receiving the equivalent value asset from the institutional investor in exchange for shares of the in-kind fund;
holding the subscription asset in the in-kind fund; and
converting the subscription shares of the in-kind fund into shares of an investment fund in the investment fund corporation.

2. The method of claim 1, further comprising converting the shares of the investment fund into redemption shares of the in-kind fund and redeeming the redemption shares for cash.

3. The method of claim 2, further comprising calculating the amount of capital gains to be distributed to the client and the institutional investor.

4. The method of claim 3, wherein the amount of capital gains realized upon redemption is shared between the client and the institutional investor.

5. The method of claim 1, wherein the investment fund further comprises at least one series of shares for investors purchasing shares of the investment fund with cash.

6. The method of claim 1, wherein the institutional investor is a financial institution, bank, holding company, insurance company, pension fund, individual investor or other institution.

7. The method of claim 1, wherein the subscription asset is a stock, security, equity, shares of a company, partnership interest, capital property, resource property, real property, or combination thereof.

8. The method of claim 1, wherein the subscription asset is an equity of one or more publicly traded companies or a capital stock of a private corporation.

9. The method of claim 1, comprising considering and/or receiving more than one subscription asset offered by the client.

10. The method of claim 1, wherein the method is done on a tax-deferred basis to the client.

11. The method of claim 1, further comprising calculating and recording the cost base of the subscription asset for the client and the investment fund corporation.

12. A method for exchanging a subscription asset for shares of an investment fund in an investment fund corporation on a tax-deferred basis, the method comprising:
considering a subscription asset offered by a client;
considering an equivalent value asset offered by an institutional investor in exchange for shares of an in-kind fund in the investment fund corporation;
receiving the subscription asset from the client in exchange for subscription shares of the in-kind fund;
receiving the equivalent value asset from the institutional investor in exchange for shares of the in-kind fund;
holding the subscription asset in the in-kind fund; and
converting the subscription shares of the in-kind fund into shares of an investment fund in the investment fund corporation.

13. A computer-implemented method for exchanging a subscription asset for shares of an investment fund in an investment fund corporation, the method comprising:
considering a subscription asset offered by a client;
considering an equivalent value asset offered by an institutional investor in exchange for shares of an in-kind fund in the investment fund corporation;
receiving, by a computer programmed to perform such receiving, the subscription asset from the client in exchange for subscription shares of the in-kind fund;
receiving, by a computer programmed to perform such receiving, the equivalent value asset from the institutional investor in exchange for shares of the in-kind fund;
holding the subscription asset in the in-kind fund of the investment fund corporation; and
converting, by a computer programmed to perform such converting, the subscription shares of the in-kind fund into shares of an investment fund in the investment fund corporation; and
tracking, by a computer programmed to perform such tracking, the subscription asset and history of transactions thereof while the asset is held by the investment fund corporation.

14. The method of claim 13, further comprising converting the shares of the investment fund into redemption shares of the in-kind fund and redeeming the redemption shares for cash.

15. The method of claim 14, further comprising calculating the amount of capital gains to be distributed to the client and the institutional investor.

16. The method of claim 15, wherein the amount of capital gains realized upon redemption is shared between the client and the institutional investor.

17. The method of claim 13, wherein the investment fund further comprises at least one series of shares for investors purchasing shares of the investment fund with cash.

18. The method of claim 13, wherein the institutional investor is a financial institution, bank, holding company, insurance company, pension fund, individual investor or other institution.

19. The method of claim 13, wherein the subscription asset is a stock, security, equity, shares of a company, partnership interest, capital property, resource property, real property, or combination thereof.

20. The method of claim 13, wherein the subscription asset is an equity of one or more publicly traded companies or a capital stock of a private corporation.

21. The method of claim 13, comprising considering and/or receiving more than one subscription asset offered by the client.

22. The method of claim 13, wherein the method is done on a tax-deferred basis to the client.
